(19) United States
(12) Patent Application Publication
(10) Pub. No.: US 2015/0217675 A1
(43) Pub. Date: Aug. 6, 2015

(54) LED SPORTS BOARD

(71) Applicant: Clear Innovation LLC, New York, NY (US)

(72) Inventors: Maurice S. Dayan, Oakhurst, NJ (US); Gu Fanghe, Ningbo (CN)

(21) Appl. No.: 14/615,592

(22) Filed: Feb. 6, 2015

Related U.S. Application Data
(60) Provisional application No. 61/936,665, filed on Feb. 6, 2014.

(51) Int. Cl. B60Q 1/02; B63B 35/73; B63B 35/79; A63C 5/03

(52) U.S. Cl. CPC B60Q 1/02; A63C 5/03; B63B 35/731; B63B 35/7906

(57) ABSTRACT

Described herein is a sports board having a light-transmissive foam body that has an outer top surface, an outer bottom surface, and an outer peripheral edge surface extending between the outer top and bottom surfaces, and a lighting circuit that includes a plurality of light sources embedded in the light-transmissive foam body such that light generated by the plurality of light sources is transmitted through the light-transmissive foam body and exits through at least one of the outer top surface or the outer peripheral edge surface.

### CROSS-REFERENCE TO RELATED PATENT APPLICATIONS

This application claims the benefit of U.S. Provisional Patent Application No. 61/936,665, filed Feb. 6, 2014, the entirety of which is incorporated herein by reference.

### BACKGROUND OF THE INVENTION

Sports boards, which are used in sporting activities that involve boards and riders, are becoming increasingly popular. Various improvements have been undertaken to boost rider appeal, enhance rider comfort, facilitate manufacture, and increase rider safety. A particular area of interest has been providing equipment that allow riders to engage in sporting activities under certain conditions, such as dusk or night time, or during a period of fog or snow, because it may be difficult to perceive fellow riders. However, these advancements have been limited and have failed to boost rider appeal in this field while maintaining comfort and ease of manufacture.

There is, therefore, a need for a sports board that satisfies growing performance needs and rider appeal while also retaining comfort and ease of manufacture. Embodiments of the present invention are directed to these and other ends.

BRIEF DESCRIPTION OF THE INVENTION

Some embodiments of the present invention provide a sports board comprising: a light-transmissive foam body comprising an outer top surface, an outer bottom surface, and an outer peripheral edge surface extending between the outer top and bottom surfaces: a slick layer coupled to the outer bottom surface of the light-transmissive foam body, the slick layer having a bottom surface that forms an exposed bottom surface of the sports board; and a lighting circuit comprising, in operable coupling, a switch, a power source, and a plurality of light sources; wherein the plurality of light sources embedded in the light-transmissive foam body such that light generated by the plurality of light sources is transmitted through the light-transmissive foam body and exits through at least one of the outer top surface or the outer peripheral edge surface.

Other embodiments provide a sports board comprising: a light-transmissive foam body comprising an outer top surface, an outer bottom surface, and an outer peripheral edge surface extending between the outer top and bottom surfaces: a slick layer coupled to the outer bottom surface of the light-transmissive foam body, the slick layer having a bottom surface that forms an exposed bottom surface of the sports board; a lighting circuit comprising, in operable coupling, a switch, a power source, and at least one light source; the light source embedded in the light-transmissive foam body such that light generated by the light source is transmitted through the light-transmissive foam body and exits through at least one of the outer top surface or the outer peripheral edge surface.

### BRIEF DESCRIPTION OF THE DRAWINGS

FIG. 1 illustrates a top view of an exemplary sports board according to an embodiment of the disclosure.

FIG. 2 illustrates a cut away top view of an exemplary sports board according to an embodiment of the disclosure.

FIG. 3 illustrates a bottom perspective view of an exemplary sports board according to an embodiment of the disclosure.

FIG. 4 illustrates a longitudinal cross-sectional view, along axis IV of FIG. 1 of an exemplary sports board according to an embodiment of the disclosure.

FIG. 5 illustrate illustrates an enlarged lateral cross-sectional view, along axis V of FIG. 1 of an exemplary sports board according to an embodiment of the disclosure.

FIGS. 6A-D illustrate elevational views of area VI defined in FIG. 5 of an exemplary sports board according to various embodiments of the disclosure.

FIGS. 7A-B illustrates cross-sectional views of area VI defined in FIG. 5 of an exemplary sports board according to various embodiments of the disclosure.

FIG. 8 illustrates a close up top view of a portion of an exemplary sports board according to an embodiment of the disclosure.

FIG. 9 illustrates a close up cross-sectional view of a portion of an exemplary sports board according to an embodiment of the disclosure.

Wherever possible, the same reference numbers will be used throughout the drawings to represent the same parts.

### DETAILED DESCRIPTION OF THE INVENTION

In some embodiments, the present invention provides a sports board having a light-transmissive foam body and a lighting circuit embedded therein.

As those skilled in the art will appreciate, numerous changes and modifications may be made to the embodiments described herein, without departing from the spirit of the invention. It is intended that all such variations fall within the scope of the invention.

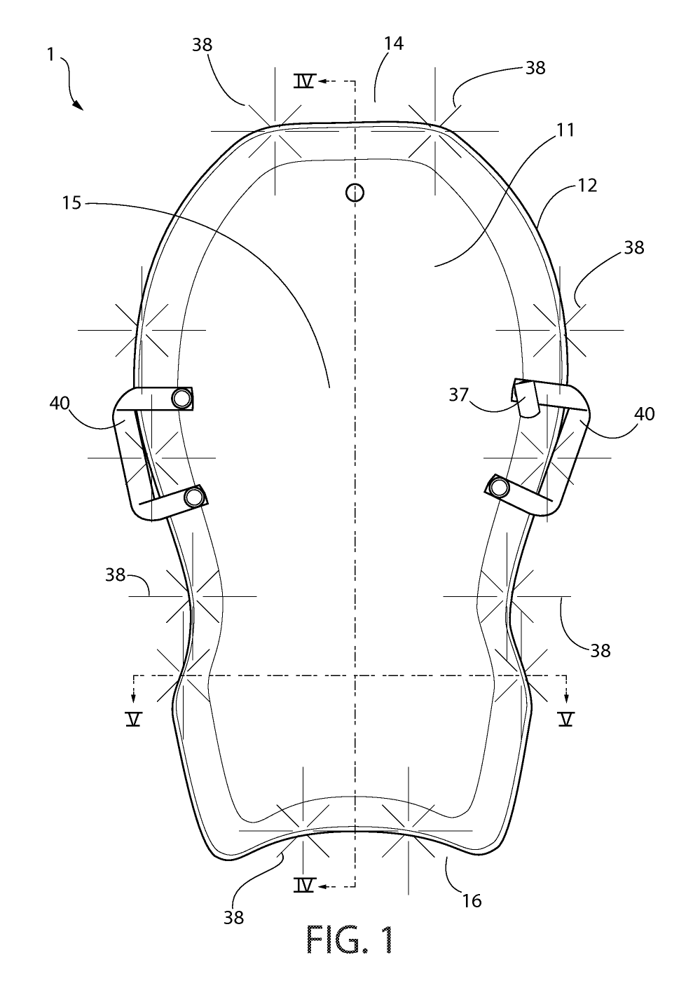

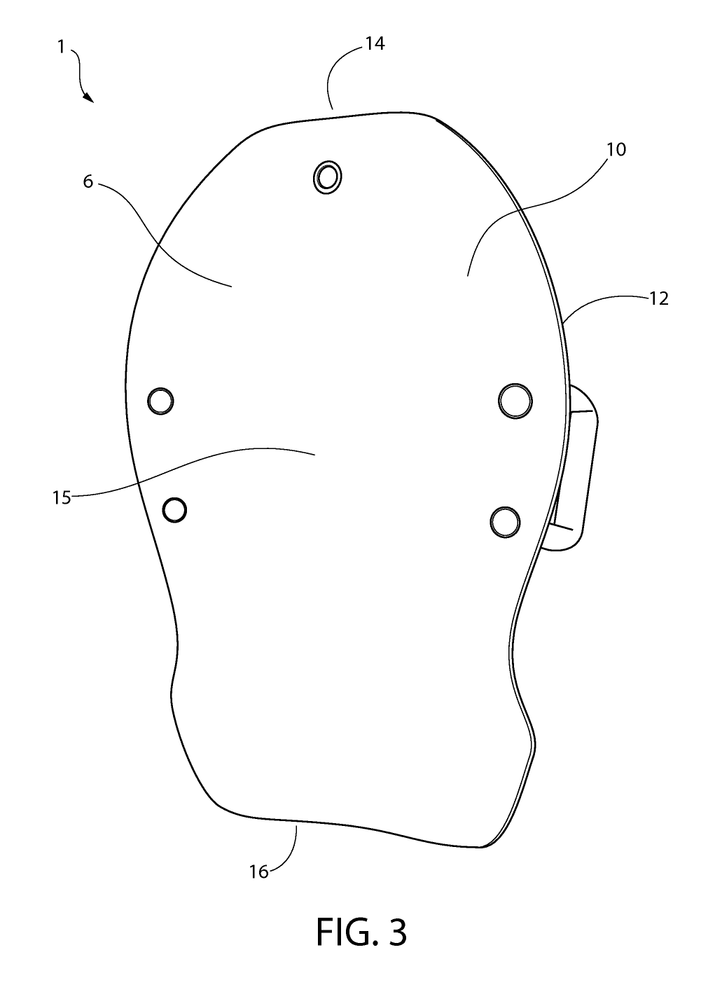

As shown in FIGS. 1 and 3, the sports board 1 of the present invention may comprise an exposed bottom surface 10, an exposed top surface 11, and an exposed peripheral edge surface 12. The sports board 1 has a length defined along axis IV and a width defined along the V axis. In some embodiments, the length may be greater than, smaller than, or equal to the width. The sports board 1 may have a leading edge 14, a body-portion 15, and a trailing edge 16. The sports board 1 may be completely flat or may have an upturned ‘nose’ approaching the leading edge 14. The upturned end may help prevent the sports board from digging into various mediums (e.g. snow, water, etc.) causing the sports board 1 to stop. The sports board 1 may also have an upturned ‘tail’ at the trailing edge 16 giving the exposed bottom surface 10 a convex shape.

The sports board 1 of the present invention may be self-supporting, meaning that the overall structure eliminates the need for additional reinforcement elements or layers, such as wood, metal, ceramic, fiberglass, composite, etc. Eliminating rigid structural materials also enhances rider comfort on the sports board 1 because the foam material, described herein, provides shock absorption.

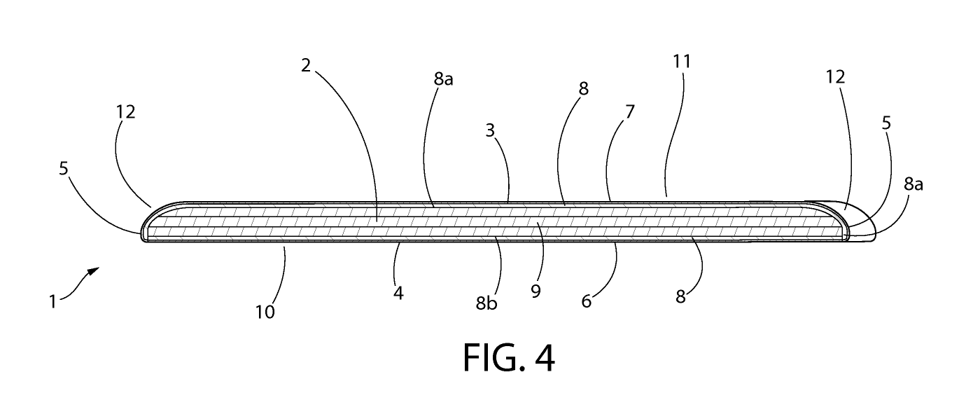

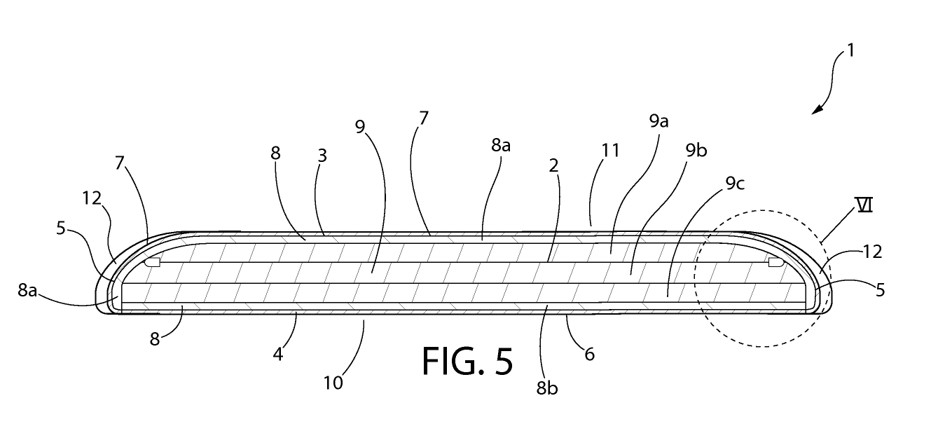

As shown in FIGS. 4 and 5, the sports board 1 of the present invention may comprise a light-transmissive foam body 2 having an outer top surface 3, an outer bottom surface 4, and an outer peripheral edge surface 5. The outer peripheral edge surface 5 may extend between the outer top surface 3 and the outer bottom surface 4.

As shown in FIGS. 3, 4, and 5, the sports board 1 may further comprise a slick layer 6 that is coupled to the outer bottom surface 4 of the light-transmissive foam body 2, such that the slick layer 6 forms the exposed bottom surface 10 of the sports board 1. As shown in FIGS. 4 and 5, the sports board 1 may further comprise a skin layer 7 that is coupled to the outer top surface 3 of the light-transmissive foam body 2, such that the skin layer 7 forms the exposed top surface 11 of the sports board 1. In another embodiment, the skin layer 7 may be coupled to the outer top surface 3 and the peripheral edge surface 5 of the light-transmissive foam body 2, the skin layer 7 forming both the exposed top surface 11 and the exposed peripheral edge surface 12 of the sports board 1. In another embodiment, the sports board 1 may exclude a skin layer 7, and the outer top surface 3 and outer peripheral edge surface 5 of the light-transmissive foam body 2 would form the exposed top surface 11 and the exposed peripheral edge surface 12 of the sports board 1, respectively.

As shown in FIGS. 4 and 5, the light-transmissive foam body 2 may comprise a shell layer 8 and a core 9. The shell layer 8 may partially or fully encapsulate the core 9. In one embodiment, the shell layer 8 fully encapsulates the core 9 forming the outer top surface 3, the outer bottom surface 4, and the peripheral edge surface 5 of the light-transmissive foam body 2.

The shell layer 8 may comprise an upper shell layer 8a and a bottom shell layer 8b. Specifically, the upper shell layer 8a may form the outer top surface 3 and the outer peripheral edge surface 5 of the foam body 2. The bottom shell layer 8b may form the outer bottom surface 4 of the light-transmissive foam body 2. The upper shell layer 8a and the bottom shell layer 8b may each have a thickness ranging from about 1/16-inch to about ¼-inch, alternatively from about ⅛-inch to about ¼-inch, alternatively from about ⅛-inch to about 3/16-inch, alternatively about ⅛-inch.

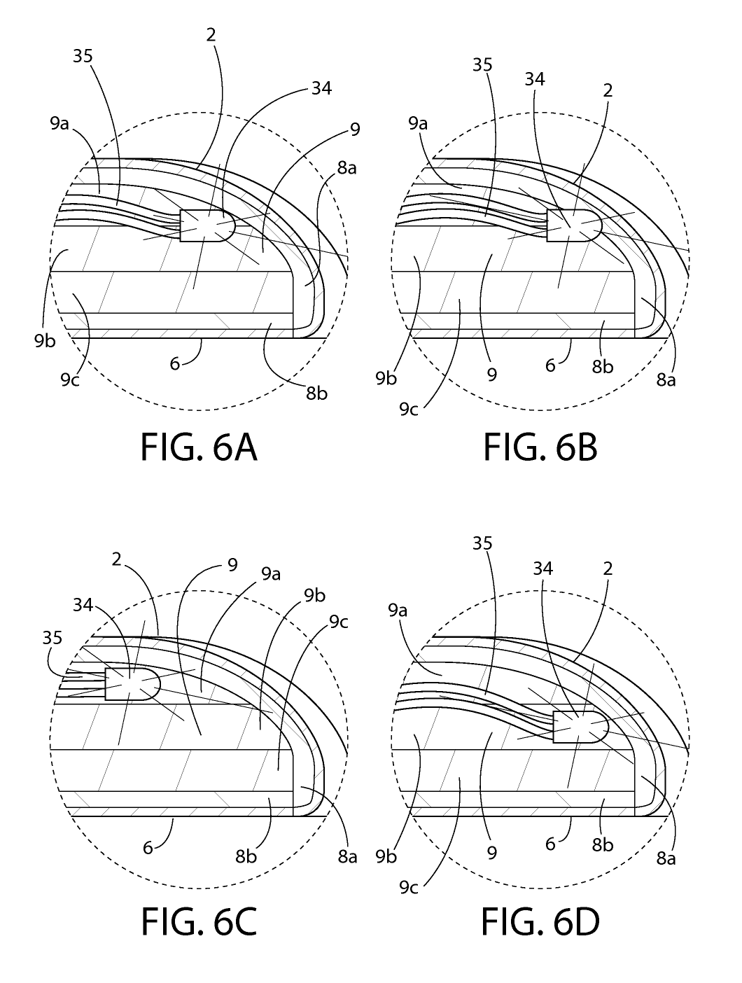

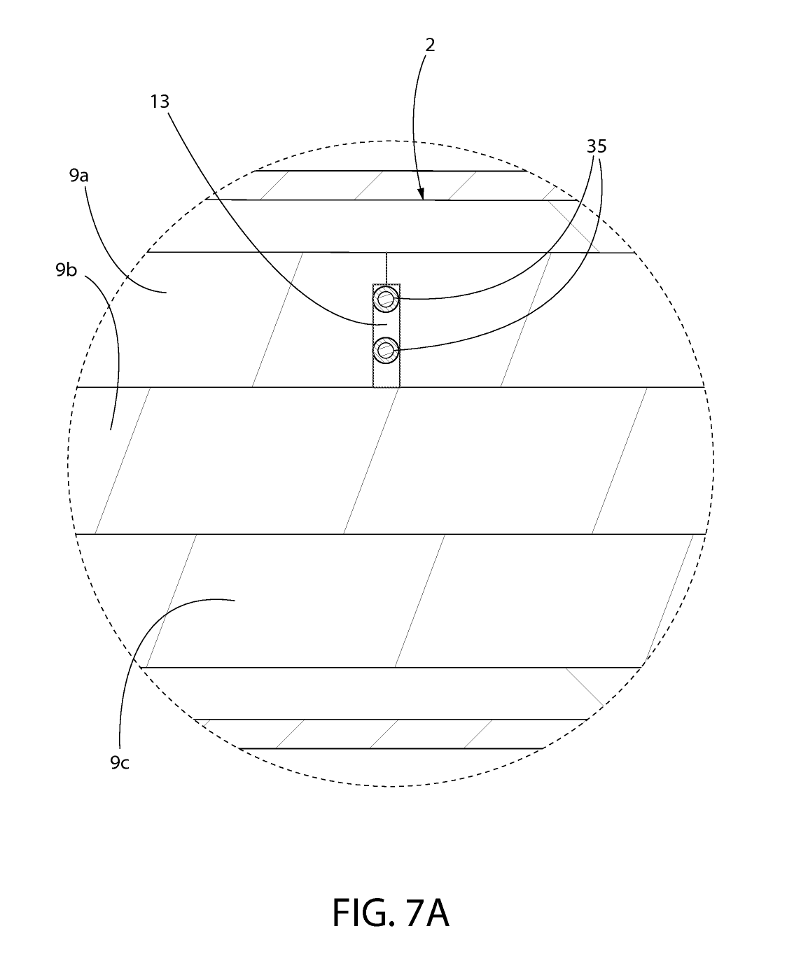

The core 9 may comprise a single core layer, or, as shown in FIGS. 6A-6D, the core 9 may comprise a plurality of core layers 9a, 9b, 9c, etc. The present invention provides that the number of core layers may range from about 1 layer to about 10 layers. The plurality of core layers 9a, 9b, 9c, etc. may form a laminate structure, discussed herein. The core 9 may have a thickness ranging from about ¼-inch to about 5-inches. Each individual core layer 9a, 9b, 9c, etc., may have a thickness ranging from about ⅛-inch to about ½-inch.

The light-transmissive foam body 2 may be a thermoplastic or a thermoset self-supporting polymer foam. The polymer foam may either be open or closed-cell foam. In some embodiments, the core 9 may be a first foam material that is closed-cell and is made of polyolefin, polyurethane, polystyrene, a copolymer thereof, and mixtures thereof. Suitable polyolefins include polyethylene and polypropylene. The first foam material may be expanded and/or cross-linked. The shell layer 8 may be a second foam material that is closed-cell and is made of polyolefin, polyurethane polystyrene, a copolymer thereof, and mixtures thereof. Suitable polyolefins include polyethylene and polypropylene. The second foam material may be cross-linked.

The first foam material may have a first density and the second foam material may have a second density. The first density may be less than, equal to, or more than the second density. The first density may range from about 1 to 10 pounds per cubic foot (pcf), alternatively from about 2 to about 4 pcf. The second density may range from about 1 to about 10 pcf, alternatively from about 4 to about 8 pcf, and alternatively about 6 pcf. In some embodiments, when the core 9 comprises a plurality of core layers 9a, 9b, 9c, etc., each core layer may have a density as follows: 9a>9b>9c>etc.; alternatively: 9a<9b<9c<etc.; alternatively: 9a=9b=9c=etc.; and alternatively the densities of each core layer 9a, 9b, 9c etc., may be selected at random. As the foam density becomes larger, the sports board 1 will exhibit greater self-supporting characteristics, however, this may be offset by decreased comfort.

In one embodiment, the top shell layer 8a is electronically cross-linked polyethylene foam (IXPE), the bottom shell layer 8b is cross-linked polyethylene foam (XPE), the core 9 comprises three layers, 9a, 9b, 9c, each of which are expanded polyethylene (EPE), and the first density is less than the second density.

The slick layer 6 imparts less drag and promotes quick release from the sliding surface (e.g. snow, ice, water, metal, plastic, sand, natural grass, and artificial turf, etc.). The slick layer 6 enhances the following: riding performance, resistance to puncture, cosmetic appearance (including the ability to receive permanent color impregnation of a logo or a design), reduced water adsorption by the sports board 1, as well as other benefits. The slick layer 6 may also be light-transmissive and made from a thermoplastic or thermoset polymer film or sheet. Suitable polymers for the slick layer 6 may include polyolefin, polyurethane, polyvinylchloride (PVC), a copolymer thereof, and mixtures thereof—all of which may be cross-linked and may be impervious to water. Suitable polyolefins include polyethylene and polypropylene. In one embodiment, the slick layer 6 is high density polyethylene (HDPE).

The slick layer 6 may have a thickness ranging from about 1 mil to about 100 mil, alternatively from about 10 to about 50 mil, alternatively from about 10 mil to about 25 mil, alternatively from about 3 mil to about 10 mil. The slick layer may have a third density that ranges from about 20 pcf to about 60 pcf. In some embodiments, the slick layer 6 may include one or more additional coatings, such as polytetrafluoroethylene, that further decreases the coefficient of friction on the exposed bottom surface 10 of the sports board 1. The slick layer 6 may have sufficient rigidity that further reduces or eliminates the need for additional reinforcing layers. The slick layer 6 may exhibit sufficient flexibility to allow the rider to deform and navigate the sports board 1 during usage. The exposed side of the slick layer 6 that forms the exposed bottom surface 10 may exhibit a coefficient of friction that allows the sports board 1 to readily slide across a number of mediums, such as snow, ice, water, metal, plastic, sand, natural grass, and artificial turf.

The skin layer 7 may also help prevent punctures and may decrease the water adsorption by the sports board 1. The skin layer 7 may also be light-transmissive and capable of receiving permanent color impregnation of a logo or design or receiving dry adhesive traction material. The skin layer 7 may be a thermoplastic or thermoset polymer film. The polymer film may be cross-linked and impervious to water. The polymer film may be made from polyolefins, polyurethane, polyamide (e.g. nylon), polyester, PVC, a copolymer thereof, and mixtures thereof. The skin layer 7 may have a thickness ranging from about 0.5 mil to about 2 mil. In some embodiments, color patterns/designs (including black, white, and grey), as well as prints (e.g. brand logos) may be permanently or temporarily applied to the skin layer 7 using adhesive, paint, and/or marker, as well as a Mylar transfer pattern using heat and pressure. The skin layer 7 may also be embossed.

The light-transmissive foam body 2, slick layer 6, and skin layer 7, may each be capable of transmitting from about 1% to about 99% of light, including all values therebetween. The shell layer 8 and the core 9 may have the same or different amounts of light transmissivity. In some embodiments, the shell layer 8 may transmit more than, less than, or the same amount of light as the core 9. In another embodiment, the shell layer 8 is formed so that the upper shell layer 8a transmits more than, less than, or the same amount of light as the lower shell layer 8b.

In some embodiments, the plurality of core layers 9a, 9b, 9c, etc. may exhibit a light transmittance relationship as follows: 9a>9b>9c>etc. In another embodiment, the plurality of core layers 9a, 9b, 9c, etc. may exhibit a light transmittance relationship as follows: 9a<9b<9c<etc. In another embodiment, the plurality of core layers 9a, 9b, 9c . . . 9j, may exhibit a light transmittance relationship as follows: 9a=9b=9c=etc. In another embodiment, the plurality of core layers 9a, 9b, 9c, etc., may have random light transmittance values. The slick layer 6 and/or the skin layer 7 may transmit the more than, less than, or the same amount of light as the light-transmissive foam body 2. The slick layer 6 may transmit more than, less than, or the same amount of light as the skin layer 7.

The amount of light transmittance may be controlled by various methods, including adding pigments and fillers to the polymer formulations, or by adding an additional pigmented or filler based layer or coating (e.g. paint) to the foam body 2, slick layer 6, or skin layer 7. Additional additives may include anti-statics, antioxidants, heat stabilizers, and UV inhibitors.

In manufacture, the sports board 1 is prepared substantially as follows. A film or sheet of HDPE (slick layer 6) and a sheet of cross-linked polyethylene (lower shell layer 8b) are laminated together at a temperature ranging from about 200° F. to about 400° F. The slick layer 6/lower shell layer 8b laminate is then air cooled and taken up on rolls and may be cut to the appropriate sports-board size at this stage. A sheet of expanded polyethylene (core 9) is then laminated to the slick layer 6/lower shell layer 8b laminate at a temperature ranging from about 200° F. to about 400° F. The closed-cells on these surfaces of the lower shell layer 8b and the core 9 open under the influence of heat, and the surfaces are brought together under compression. The heat and pressure enable a laminate to be formed. In some embodiments, additional core layers 9a, 9b, 9c, etc. may be laminated to the unlaminated foam side of the previously made slick layer 6/lower shell layer 8b/core layer 9 laminate according to the lamination method previously discussed. Additional core layers 9a, 9b, 9c, etc. may be additionally laminated until the desired number of core layers 9a, 9b, 9c, etc. is achieved.

After air cooling, in one embodiment the slick layer 6/lower shell layer 8b/core layer 9 laminate may be cut according to the desired out-line shape of the sports board 1. In some embodiments, the slick layer 6 may be precut to the desired shape before lamination begins. In another embodiment, the slick layer 6/lower shell layer 8b may be cut to the desired shape before the core layer 9 is laminated thereon. Once the core layer 9 is laminated to the slick layer 6/lower shell layer 8b, the core layer 9 may be cut to the desired shape. Alternatively, the slick layer 6/lower shell layer 8b/core layer 9 laminate may be cut to the desired shape at the same time.

The upper shell layer 8a is laminated to both the top side of the core 9 at a temperature ranging from about 200° F. to about 400° F. The upper shell layer 8a is then laminated over the peripheral edges of the core 9 according to the lamination method previously discussed. The method of manufacture results in the bottom surface of the core 9 being encased by the lower shell layer 8b and the top and peripheral surfaces of the core being encased by the top shell layer 8a. To ensure proper lamination, a heat gun may be used to directly heat certain or all areas of the light-transmissive foam body 2 during manufacture. Specifically, a heat gun may apply heat to the peripheral edges of the core 9 so that the upper shell layer 8a properly forms both the outer top surface 3 and the peripheral edge surface 5 of the light-transmissive foam body 2. The pressure may be applied by hand, iron, roller, or press. The sports board 1 is then air cooled.

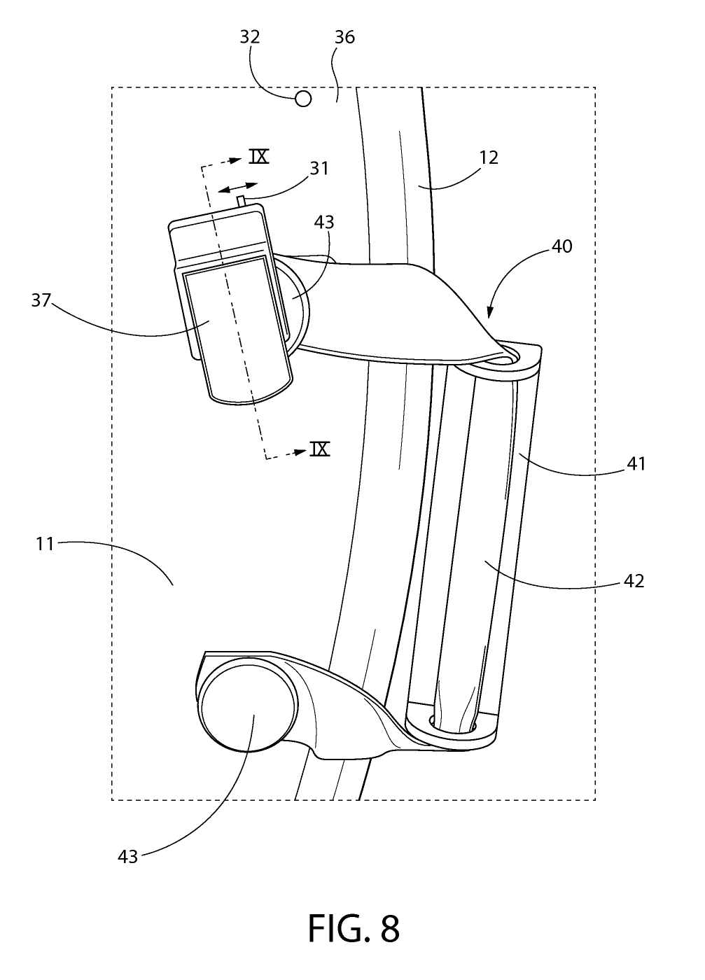

As shown in FIGS. 1 and 8, the sports board 1 of the present invention has one or more handles 40 to which a rider may hold during use. In one embodiment, the sports board 1 has a pair of handles 40 that may be located within the body-portion 15 of the sports board 1, and positioned adjacent to the exposed peripheral edge 12. In another embodiment, the sports board 1 has two or more pairs of handles 40 to accommodate two or more riders seated together on the sports board 1. Handles may also be located on the leading edge 14 and/or the trailing edge of the sports board 1.

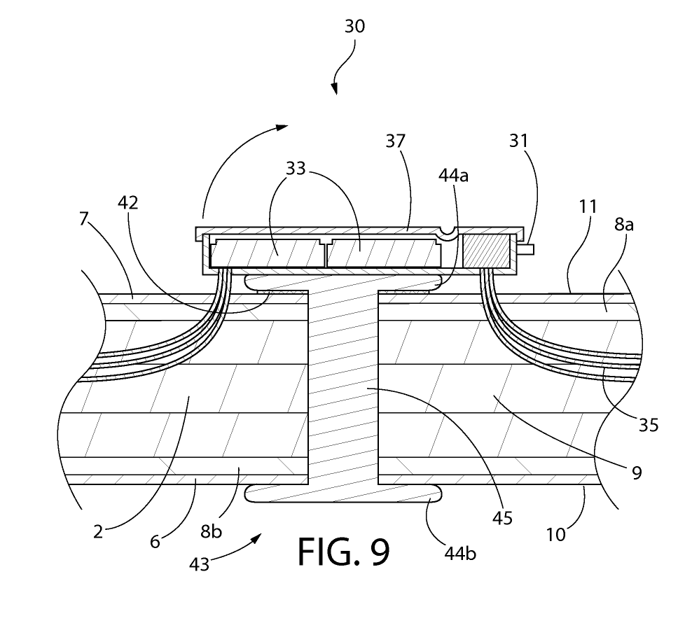

As shown in FIGS. 8 and 9, the handles 40 may comprise a grip 41, a strap 42, and at least one anchor element 43. In one embodiment, at least one handle 40 is coupled to the light-transmissive foam body 2 by at least one anchor element 43.

The anchor element 43 may be I-shaped and comprise an anchor body 45, a first anchor flange 44a, and a second anchor flange 44b. The first anchor flange 44a is positioned adjacent to the outer top surface 3 of the light-transmissive foam body 2. The second anchor flange 44b is positioned adjacent the bottom surface of the slick layer 6. The anchor body 45 extends through both the light-transmissive foam body 2 and the slick layer 6, connecting the first and second anchor flanges 44a, 44b. In embodiments where the sports board 1 further comprises a skin layer 7, the anchor body 45 extends through the skin layer 7, the foam body 2, and the slick layer 6, connecting the first and second anchor flanges 44a, 44b. The anchor element 43 may be cylindrical or polygonal.

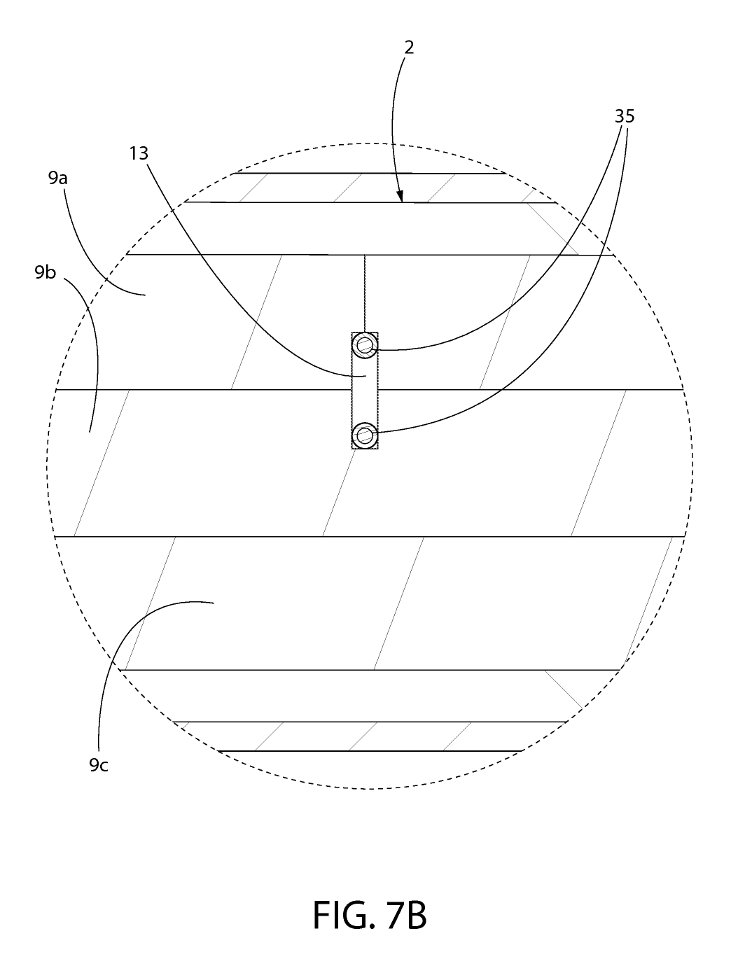

The strap 42 may have two ends. At least one end of the strap 42 may have a hole that receives a portion of the anchor body 45 so that the strap 42 is positioned between the first anchor flange 44a and the light-transmissive foam body 2 (as shown in FIG. 7), or, alternatively, between the second anchor flange 44b and the light-transmissive foam body 2 (not shown). Each strap 42 may be coupled between two anchor elements 43, or, alternatively, each end of the strap 42 may be coupled to the same anchor element 42, creating a loop. The grip 41 may be coupled to the strap 42. The grip 41 provides an additional surface for the rider to grasp, thereby enhancing the rider's comfort and stability on the sports board 1.

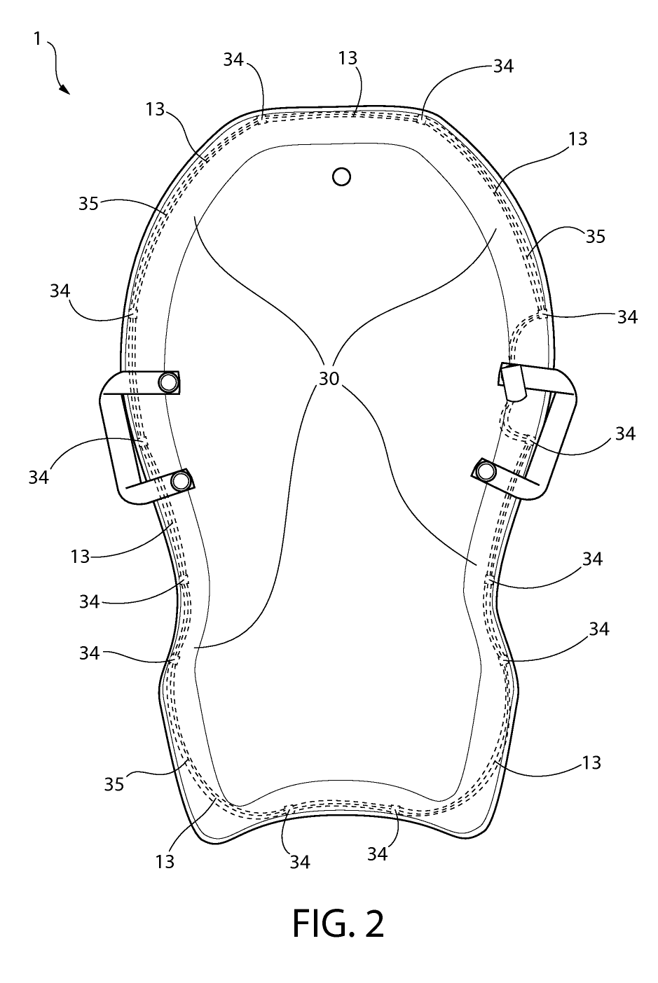

As demonstrated in FIGS. 2, 8, and 9, the sports board 1 may further comprise a lighting circuit 30. The lighting circuit 30 may include an ON/OFF switch 31, a mode switch 32, a power source 33, a plurality of light sources 34, wiring 35, and a controller 36, all of which are in operable coupling. The ON/OFF switch 31 may change the lighting circuit 30 between an ON and OFF position. In the OFF position, the lighting circuit 30 cannot being activated. In the ON position, the rider may press the mode switch 32 to activate the lighting circuit 30. Once activated, the controller 36 may cause the plurality of light sources 34 to perform one or more lighting functions discussed herein. The ON/OFF switch 31 and mode switch 32 may be any suitable configuration or type, such as a push-button, plunger, toggle, or slide.

In some embodiments, the handle 40 comprises a housing 37 that may house the power source 33 and the ON/OFF switch 31. The housing 37 may be connected to an upper surface of the first anchor flange 44a. In some embodiments, the housing 37 may also house the mode switch 32 and/or the controller 36. Alternatively, the controller 36 and/or the mode switch 32 may be positioned within the light-transmissive foam body 2.

The power source 33 includes any appropriate type of battery/power source, including alkaline batteries, nickel-metal hydride batteries, and lithium batteries—both one time use and rechargeable batteries. In some embodiments, the power source 33 may include a solar panel.

The lighting circuit 30 may be positioned about the sports board 1 in a number of configurations. In one embodiment shown in FIGS. 1 and 2, the lighting circuit 30 has the plurality of light sources 34 positioned around the body of the sports board 1 and adjacent the peripheral edge surface 5 of the light-transmissive foam body 2. In this configuration, the lighting circuit 30 generally follows the outline shape of the sports board 1. In other embodiments, the lighting circuit may be centralized within the sports board 1, for example, along the longitudinal axis IV.

The lighting circuit 30 may also be positioned within the sports board 1 in a number of configurations. In one embodiment, the plurality of light sources 34 are embedded in the light transmissive foam body 2 such that the light generated by the plurality of light sources 34 is transmitted through the light-transmissive foam body 2 and exits through both the outer top surface 3, the outer peripheral edge 5, and/or the outer bottom edge 4 of the foam body 2. In another embodiment, the plurality of light sources 34 are embedded in the light transmissive foam body 2 such that the light generated by the plurality of light sources 34 is transmitted through the light-transmissive foam body 2, the slick layer 6 and the skin layer 7 and exits through the exposed bottom surface 10, the exposed top surface 11, and/or the exposed peripheral edge 12 of the sports board 1.

As shown in FIG. 1, the light-transmissive foam body 2, may further comprises a plurality of illumination regions 38 located about a perimeter of the light-transmissive foam body 2 in a spaced apart manner. Each of the plurality of illumination regions 38 may comprise at least one of the plurality of light sources 34. The illumination regions 38 occupy at least a portion of the light-transmissive foam body 2, the slick layer 6, and/or the skin layer 7. When the plurality of light sources 34 are illuminated, the emitted light is diffused by the light-transmissive foam body 2, the slick layer 6, and/or the skin layer 7. The light diffusion creates a glowing effect that defines the volume of the illumination region 38. The volume of the sports board 1 covered by the illumination regions 38 may extend in multiple directions across the exposed bottom surface 10, exposed top surface 11, and/or exposed peripheral edge 12 of the sports board 1. Although each plurality of light sources 34 may occupy a relatively small volume within the sports board 1, the diffusion of light results in relatively larger volumes occupied by the illumination regions 38 within the sports board 1. The illumination regions 38 may extend through the total thickness of the sports board 1 as well as up to several inches (e.g. up to six inches) across the exposed bottom and top surfaces 10, 11, as well as exposed peripheral edge 12 of the sports board 1.

Furthermore, because the sports board 1 is self-supporting and does not require reinforcing material, the glow in each illumination region 38 may be unhindered or unblocked by wood, metal, etc. reinforcement layers. The illumination region 38 may range from about 1 to about 100 times the volume of each plurality of light sources 34. The final volume of each illumination region 38 will depend on the light transmittance properties of the surrounding materials as well as the number and strength of each plurality of light sources 34.

In one embodiment, each of the illumination region 38 may comprise a first plurality of light sources 34 and a second plurality of light sources 34, the first and the second plurality of lights sources 34 being adjacent to one another. The first plurality of light sources 34 may generate light of a first color and the second plurality of light sources 34 may generate light of a second color, wherein the second color is different than the first color.

In one embodiment, the light transmissive foam body 2 imparts a mixing, diffusing, and/or combining effect on the first and second of the plurality of light sources 34 resulting in the light exiting the light-transmissive foam body 2 is a third color—the third color being a combination of the first and second color. For example, the first plurality of light sources 34 emits blue light and the second plurality of light sources 34 emits red light. The light from the first and second plurality of light sources 34 may combine into purple light. Other non-limiting examples may include blue light and yellow light combining into green light, as well as yellow light and red light combining into orange light.

The controller 36 may be configured so that upon pushing the mode button 32, the first plurality of light sources 34 is brightened while the second plurality of light sources 34 is darkened, yielding a first color (e.g. yellow). Upon pushing the mode button 32 again, or after a predetermined delay, the second plurality of light sources 34, having a second color (e.g. blue), is brightened. The addition of the second color combines with the first color to yield a third color (e.g. green—the combination of blue and yellow). After pushing the mode button 32 a third time, or after another predetermined delay, the first plurality of light sources 34 may be dimmed to transition from the third color to the second color (e.g. blue). The controller 36 may create a cycle that repeats the brightening and dimming steps.

The foregoing lighting configurations are not limited to two pluralities of light sources 34. Each illumination region 38 may comprise two or more plurality of light sources 34, each emitting a different color. The predetermined delay can be any amount of time, for example, from about one second to about one minute. The number of plurality of light sources 34 may range from 1 to about 100.

In another embodiment, the controller 36 may also be preprogramed illuminate the plurality of light sources 34 for simultaneously, alternating, or offset patterns of flashing, strobing, dimming, or brightening, wherein the patterns cycle at predetermined delays. The number of illumination regions 38 may vary from 1, 2, 3, 4, 5, 6, 7, 8, 9, 10, 11, 12, 13, 14, 15, 16, 17, 18, 19, or 20 and may be evenly or unevenly spaced around the perimeter or the body of the sports board 1.

The plurality of light sources 34 may be selected from light emitting diodes (LED), fiber optic cables/fibers, halogen bulbs, filament-based bulbs, lasers, incandescent bulbs, and a combination thereof. Each plurality of light sources 34 may be capable of emitting at least one type of color—may be selected from the entire visible color spectrum as well as black and white. In some embodiments, each individual plurality of light sources 34 may comprise a single or multiple LEDs, each capable of producing a single color or multiple colors.

As shown in FIGS. 6A-6D, the lighting circuit 30 may be positioned within the sports board 1 such that the wiring 35 and plurality of light sources 34 are embedded in light-transmissive foam body 2—i.e. in direct contact with and surrounded by the light-transmissive foam body 2. Specifically, the plurality of light sources 34 may be positioned within the light-transmissive foam body 2 so that each plurality of light sources 34 are fully embedded in the core 9 (as shown in FIGS. 6A, 6C, and 6D). In another embodiment, the plurality of light sources 34 may be positioned between the core 9 and the shell layer 9 such that each plurality of light sources 34 is partially embedded in the core 9 and partially embedded in the shell layer 8.

In another embodiment, lighting circuit 30 may be positioned such that only some of the plurality of light sources 34 are fully embedded in the core 9 while the remaining amount of the plurality of light sources 34 are partially embedded in the core 9. When the light-transmissive foam body 2 comprises core layers 9a, 9b, 9c, etc., the plurality of light sources 34 may be embedded entirely within a single core layer, for example the uppermost layer, 9a, as shown in FIG. 6C, or another layer, such as 9b, as shown in FIG. 6D. The plurality of lights sources 34 may also be positioned partially between two core layers, such as 9a and 9b, as shown in FIG. 6A. In some embodiments, when a plurality of light sources 34 are positioned within a single core layer 9a, 9b, 9c, etc., the plurality of light sources 34 maybe surrounded entirely by the core layer 9a, 9b, 9c, etc. or surrounded partially by the core layer 9a, 9b, 9c, etc. and partially by the shell layer 8, as demonstrated in FIG. 6B.

As shown in FIGS. 2, 7A, and 7B, the core 9 may comprise channels 13 that provide a pathway for the wiring 35 and the plurality of light sources 34 to navigate throughout the light-transmissive foam body 2. The channels 13 may be produced by cutting the core 9 with a knife prior to lamination of the upper shell layer 8a. As shown in FIGS. 6C and 7A, a core 9 having a plurality of core layers 9a, 9b, 9c, etc. may have the channel 13 exist in a single core layer 9a. As shown in FIGS. 6A, 6B, 6D, and 7B, a core 9 having a plurality of core layers 9a, 9b, 9c, etc. may have the channel exist across multiple core layers 9a, 9b, 9c, etc. In one embodiment and as shown in FIGS. 9 and 6A, the channels 13 may be positioned solely in the top most core layer 9a.

The self-supporting structure of the sports board 1 provides that the plurality of light sources 34 may be in direct contact with the surrounding core 9 and/or shell layer 8. The direct contact with the surrounding core 9 and/or shell layer 9 eliminates the need to add additional encasement protection around the plurality of light sources 34, such as translucent glues, structural sheets, potting material, resins, or tape, e.g. plexi-glass, epoxy resin, or silicone. The need for additional encasement protection may be further reduced or eliminated by additional strength provided by the slick layer 6 and, optionally, the skin layer 7. The sports board 1 may be free of reinforcement layers of wood, metal, ceramic, or fiberglass. Nonetheless, in some embodiments, the plurality of light sources 34 may include such additional encasement protection.

The sports board 1 of the present invention may be useful for sliding on snow, ice, water, metal, plastic, sand, natural grass, artificial turf, etc., preferably on a downward slope. Such devices are commonly referred to as, for example, sleds, toboggans, body boards, and boogie boards.

What is claimed is:

1. A sports board comprising:
a light-transmissive foam body comprising an outer top surface, an outer bottom surface, and an outer peripheral edge surface extending between the outer top and bottom surfaces:
a slick layer coupled to the outer bottom surface of the light-transmissive foam body, the slick layer having a bottom surface that forms an exposed bottom surface of the sports board;
a lighting circuit comprising, in operable coupling, a switch, a power source, and a plurality of light sources;
the plurality of light sources embedded in the light-transmissive foam body such that light generated by the plurality of light sources is transmitted through the light-transmissive foam body and exits through at least one of the outer top surface or the outer peripheral edge surface.

2. The sports board of claim 1 wherein the light-transmissive foam body comprises a shell layer that encapsulates the plurality of light sources, the shell layer comprising the outer top surface, the outer bottom surface, and the outer peripheral edge surface of the light-transmissive foam body.

3. The sports board of claim 2 wherein the light-transmissive foam body comprises a core encapsulated by the shell layer.

4. The sports board of claim 3 wherein the shell layer comprises a first foam material having a first density and the core comprises a second foam material having a second density, the second density being less than the first density.

5. The sports board of claim 4 wherein the shell layer comprises a top portion and a bottom portion, the top portion comprising the outer and peripheral edge surfaces of the light-transmissive foam body, and the bottom portion comprising the outer bottom surface of the light-transmissive foam body.

6. The sports board of claim 5 wherein the first and second foam material is an expanded polyolefin.

7. The sports board of claim 3 wherein the plurality of lights are positioned between the shell layer and the core.

8. The sports board of claim 3 wherein the plurality of lights are embedded in the core.

9. The sports board of claim 8 wherein the core comprises a plurality of core layers, the plurality of light sources nesting in an uppermost layer of the plurality of core layers.

10. The sports board of claim 3 wherein the light circuit further comprises, in operable coupling, a plurality of wires extending between the plurality of light sources and the power source, wherein the plurality of wires are nested within grooves in a top surface of the core.

11. The sports board of claim 1 further comprising:
at least one handle coupled to at least one of the light-transmissive foam body or the slick layer by at least one an anchor element comprising a housing;
at least a portion of the light circuit disposed within the housing.

12. The sports board of claim 11 wherein the anchor element further comprises a first anchor flange positioned adjacent the bottom surface of the slick layer, a second anchor flange positioned adjacent the outer top surface of the light-transmissive foam body, and an anchor body extending through both the light-transmissive foam body and the slick layer connecting the first and second anchor flanges.

13. The sports board of claim 12 wherein the housing is connected to an upper surface of the first anchor flange.

14. The sports board of claim 12 wherein the anchor body comprises a cavity, the anchor body forming the housing.

15. The sports board of claim 12 wherein the power source is located within the housing.

16. The sports board of claim 15 wherein the light circuit further comprises a controller, the controller located within the housing.

17. The sports board of claim 1 wherein the light-transmissive foam body further comprises a plurality of illumination regions located about a perimeter of the light-transmissive foam body in a spaced apart manner; and wherein each of the plurality of illumination regions comprises at least one of the plurality of light sources.

18. The sports board of claim 17 wherein each of the illumination regions comprises a first one of the plurality of light sources and a second one of the plurality of light sources, the first and second ones of the plurality of light sources being adjacent to one another.

19. The sports board of claim 18 wherein the first one of the plurality of light sources generates light of a first color and the second one of the plurality of light sources generates light of a second color, the second color being different than the first color.

20. The sports board of claim 19 wherein for each of the illumination regions, the light-transmissive foam body mixes the light generated by the first and second ones of plurality of light sources such that light exiting the light-transmissive foam body is a third color, the third color being a combination of the first and second color.

21. The sports board of claim 1 wherein the bottom surface of the slick layer is convex.

22. The sports board of claim 1 wherein the plurality of light sources are embedded in the light-transmissive foam body such that light generated by the plurality of light sources is transmitted through the light-transmissive foam body and exits through both the outer top surface and the outer peripheral edge surface.

23. A sports board comprising:
a light-transmissive foam body comprising an outer top surface, an outer bottom surface, and an outer peripheral edge surface extending between the outer top and bottom surfaces:
a slick layer coupled to the outer bottom surface of the light-transmissive foam body, the slick layer having a bottom surface that forms an exposed bottom surface of the sports board;
a lighting circuit comprising, in operable coupling, a switch, a power source, and at least one light source;
the light source embedded in the light-transmissive foam body such that light generated by the light source is transmitted through the light-transmissive foam body and exits through at least one of the outer top surface or the outer peripheral edge surface.
